(19) United States
(12) Patent Application Publication
(10) Pub. No.: US 2007/0198504 A1
(43) Pub. Date: Aug. 23, 2007

(54) Calculating level-based importance of a web page

(75) Inventors: Guang Feng, Beijing (CN); Tie-Yan Liu, Beijing (CN); Wei-Ying Ma, Beijing (CN)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/360,987

(22) Filed: Feb. 23, 2006

(51) Int. Cl. G06F 17/30

(52) U.S. Cl. 707/5

(57) ABSTRACT

A method and system for determining importance of web pages that factors in the level of the web page within a web site hierarchy is provided. The importance system calculates the importance of web pages based on links between web pages. The importance system calculates a weight for a link between a from web page and a to web page based on the level of the from web page within its web site hierarchy. The importance system may use various algorithms for calculating the importance of web pages that factor in the weights of the links. The importance system may also factor in the level of a to web page within a web site hierarchy when calculating the weight of a link between a from web page and the to web page.

### BACKGROUND

Many search engine services, such as Google and Overture, provide for searching for information that is accessible via the Internet. These search engine services allow users to search for display pages, such as web pages, that may be of interest to users. After a user submits a search request (i.e., a query) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of root web pages to identify all web pages that are accessible through those root web pages. The keywords of any particular web page can be identified using various well-known information retrieval techniques, such as identifying the words of a headline, the words supplied in the metadata of the web page, the words that are highlighted, and so on. The search engine service identifies web pages that may be related to the search request based on how well the keywords of a web page match the words of the query. The search engine service then displays to the user links to the identified web pages in an order that is based on a ranking that may be determined by their relevance to the query, popularity, importance, and/or some other measure.

Three well-known techniques for ranking of web pages are PageRank, HITS (“Hyperlinked-Induced Topic Search”), and DirectHIT. PageRank is based on the principle that web pages will have links to (i.e., “outgoing links”) important web pages. Thus, the. importance of a web page is based on the number and importance of other web pages that link to that web page (i.e., “incoming links”). In a simple form, the links between web pages can be represented by adjacency matrix A, where Aᵢⱼ represents the number of outgoing links from web page i to web page j. The importance score wⱼ for web page j can be represented by the following equation:
wⱼ=Σᵢ Aᵢⱼ wᵢ

This equation can be solved by iterative calculations based on the following equation:
A^{T} w=w
where w is the vector of importance scores for the web pages and is the principal eigenvector of A^{T}.

The HITS technique is additionally based on the principle that a web page that has many links to other important web pages may itself be important. Thus, HITS divides “importance” of web pages into two related attributes: “hub” and “authority.” “Hub” is measured by the “authority” score of the web pages that a web page links to, and “authority” is measured by the “hub” score of the web pages that link to the web page. In contrast to PageRank, which calculates the importance of web pages independently from the query, HITS calculates importance based on the web pages of the result and web pages that are related to the web pages of the result by following incoming and outgoing links. HITS submits a query to a search engine service and uses the web pages of the result as the initial set of web pages. HITS adds to the set those web pages that are the destinations of incoming links and those web pages that are the sources of outgoing links of the web pages of the result. HITS then calculates the authority and hub score of each web page using an iterative algorithm. The authority and hub scores can be represented by the following equations:

$$a ( p ) = {\sum }_{q \to p} h ( q ) and h ( p ) = {\sum }_{p \to q} a ( q )$$

where a(p) represents the authority score for web page p and h(p) represents the hub score for web page p. HITS uses an adjacency matrix A to represent the links. The adjacency matrix is represented by the following equation:

$${b}_{ij} = \{ \begin{matrix}1 if page i has a link to page j , \\ 0 otherwise\end{matrix}$$

The vectors a and h correspond to the authority and hub scores, respectively, of all web pages in the set and can be represented by the following equations:
a=A^{T} h and h=Aa
Thus, a and h are eigenvectors of matrices A^{T} A and AA^{T}. HITS may also be modified to factor in the popularity of a web page as measured by the number of visits. Based on an analysis of click-through data, bᵢⱼ of the adjacency matrix can be increased whenever a user travels from web page i to web page j.

DirectHIT ranks web pages based on past user history with results of similar queries. For example, if users who submit similar queries typically first selected the third web page of the result, then this user history would be an indication that the third web page should be ranked higher. As another example, if users who submit similar queries typically spend the most time viewing the fourth web page of the result, then this user history would be an indication that the fourth web page should be ranked higher. DirectHIT derives the user histories from analysis of click-through data.

The effectiveness of a search engine service depends in large part on its accuracy in ranking web pages of search results. For search engines that rank search results at least in part based on importance, it is crucial to accurately assess the importance of web pages.

### SUMMARY

A method and system for determining importance of web pages that factors in the level of the web page within a web site hierarchy is provided. The importance system calculates the importance of web pages based on links between web pages. The importance system calculates a weight for a link between a from web page and a to web page based on the level of the from web page within its web site hierarchy. The importance system may use various algorithms for calculating the importance of web pages that factor in the weights of the links. The importance system may also factor in the level of a to web page within a web site hierarchy when calculating the weight of a link between a from web page and the to web page.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1A, 1B, and 1C illustrate different scenarios resulting in different relative weights of links between web pages based on level and relatedness.

FIG. 2 is a block diagram that illustrates components of the importance system in one embodiment.

FIG. 3 is a flow diagram that illustrates the processing of the determine importance component of the importance system in one embodiment.

FIG. 4 is a flow diagram that illustrates the processing of the generate weight matrix component of the importance system in one embodiment.

FIG. 5 is a flow diagram that illustrates the processing of the generate punishment matrix component of the importance system in one embodiment.

### DETAILED DESCRIPTION

A method and system for determining importance of web pages that factors in the level or depth of the web page within a web site hierarchy is provided. In one embodiment, the importance system calculates the importance of web pages based on links between web pages. The importance system calculates a weight for a link between a from web page and a to web page based on the level of the from web page within its web site hierarchy. For example, if an ancestor web page and a descendent web page within a web site both contain an outgoing link to the same to web page, then the weight of the link between the ancestor web page and the to web page will be greater than the weight of the link between the descendent web page and the to web page. In general, a developer of a web site will likely be more selective and deliberate in adding outgoing links to high-level web pages. As a result, an outgoing link on a high-level web page may be considered a more authoritative recommendation of a web page than an outgoing link on a low-level web page to the same web page. As another example, the more distant the relationship between a from web page and a to web page, the greater the weight of the link between the web pages. In general, closely related web pages within a web site hierarchy are likely to have many links between them for organization purposes, rather than for purposes that may indicate an authoritative recommendation. As a result, an outgoing link on a distantly related web page may be considered more important than a link on a closely related web page. The importance system may use various algorithms for calculating the importance of web pages that factor in the weights of the links. For example, the importance system may use a HITS-based algorithm, a PageRank-based algorithm, and so on. In this way, the importance system can factor in the level of web pages within a web site hierarchy in determining the importance of web pages.

In one embodiment, the importance system factors in the level of a to web page within a web site hierarchy when calculating the weight of a link between a from web page and the to web page. A higher-level web page may in general be considered to more important, and thus a more authoritative recommender, than a lower-level web page. Thus, the importance system may establish higher weight for links to higher-level web pages. When calculating the weight of the link, the importance system may factor in the level of both the from web page and the to web page within their web site hierarchies.

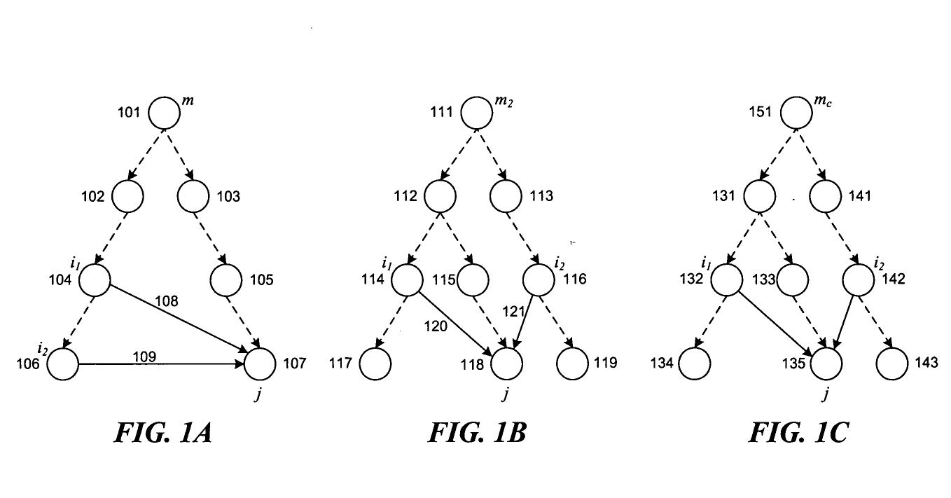

FIGS. 1A, 1B, and 1C illustrate different scenarios resulting in different relative weights of links between web pages based on level and relatedness. FIG. 1A illustrates a web site with an ancestor web page and a descendent web page with outgoing links to the same web page. In this example, web page 101 is the root web page of the web site and is at level 1, which is the highest level within the web site. The web pages are represented by circles and the hierarchy of web pages is indicated by the dashed lines between the circles. In this example, web page 101 is an ancestor of web pages 102-107, and web page 104 is an ancestor of web page 106. Web pages 102 and 103 are at level 2, web pages 104 and 105 are at level 3, and web pages 106 and 107 are at level 4. The identifying of a web site hierarchy is described in U.S. patent application Ser. No. 11/273,715, entitled “Hierarchy-Based Propagation of Contribution of Documents,” which is hereby incorporated by reference. The solid lines between the circles indicate links between web pages. In this example, link 108 represents an outgoing link from web page 104 to web page 107, and link 109 represents an outgoing link from web page 106 to web page 107. The closest common ancestor of web page 104 and web page 107 is web page 101. Similarly, the closest common ancestor of web page 106 and web page 107 is web page 101. Since the level of web page 106 is greater than the level of web page 104, the importance system sets the weight of link 108 to be greater than the weight of link 109. This relationship can be represented by the following equation:
w_{j|i}_{₁}>w_{j|i}_{₂}, when lᵢ_{₁}<lᵢ_{₂} and l_{anc(i}_{₁}_{,j)}=l_{anc(i}_{₂}_{,j)} (1)
where w_{j|i}_{₁} represents the weight of the link from web page i₁ to web page j and lᵢ_{₁} represents the level of web page i₁, and anc(i₁,j) is the closest common ancestor of web page i₁ and web page j.

FIG. 1B illustrates a web site with web pages that do not have an ancestor/descendent relationship with links to another web page of the web site. In this example, the web site hierarchy includes web pages 111-119. Web page 114 contains an outgoing link 120 to web page 118, and web page 116 contains an outgoing link 121 to web page 118. The closest common ancestor between web page 114 and web page 118 is web page 112, and the closest common ancestor between web page 116 and web page 118 is web page 111. As a result, web page 114 is considered more closely related than web page 116 to web page 118. As such, the importance system sets the weight of link 121 to be greater than the weight of link 120. This relationship can be represented by the following equation:
w_{j|i}_{₁}>w_{j|i}_{₂}, when lᵢ_{₁}<lᵢ_{₂} and l_{anc(i}_{₁}_{,j})=l_{anc(i}_{₂}_{,j)} (2)

In one embodiment, the importance system may calculate the weight of a link to satisfy Equations 1 and 2 according to the following equation:

$${\tilde{w}}_{j \vert i} = \frac{1}{{l}_{i} \cdot {l}_{anc ( i , j )}} \qquad ( 3 )$$

where w_{j|i}_{₁} represents the weight for link i from web page i to web page j. As an example of weights, if web page i is at level 3 and the closest common ancestor between web page i and web page j at level 2, then the importance system sets the weight of the link to ⅙. If, however, web page i is at level 2, then the importance system sets the weight of the link to ¼, which is greater than ⅙. If web page i is at level 3 and the closest common ancestor is at level 1, then the importance system sets the weight of the link to ⅓, which is greater than ¼ and ⅙. Equation 3 is just one example of a function to calculate the weight of a link based on level of the web pages. Other functions may include a non-linear function in which the weights of web pages vary non-linearly based on level, linear functions with different biases for different levels, and so on.

FIG. 1C illustrates links between web pages of different web sites. In this example, web pages 131-135 form the web site hierarchy of one web site, and web pages 141-143 form the web site hierarchy of another web site. Web pages 132 and 142 both contain outgoing links to web page 135. Because web pages 132 and 142 are in different web sites, they have no common ancestors. The importance system defines a virtual root web page 151 that serves as the common ancestor for web pages of different web sites. Although the root web page 151 may be logically considered to be at level 0, the importance system in one embodiment establishes its level to be 0.1 to prevent division by zero in Equation 3.

The importance system represents the weights of links in an adjacency matrix according to the following equation:

$${\tilde{L}}_{ij} = \{ \begin{matrix}{w}_{j \vert i} , & if < i , j > ∈ E \\ 0 , & otherwise\end{matrix} \qquad ( 4 )$$

where \tilde{L}ᵢⱼ represents the weight of the outgoing link from web page i to web page j.

The importance system may substitute the weight adjacency matrix in the HITS formula for calculating hub and authority scores. The substitution results in the following equations:

$${a}^{( t + 1 )} = {\tilde{L}}^{T} {h}^{( t )} = ( {\tilde{L}}^{T} \tilde{L} ) {a}^{( t )} \\ {h}^{( t + 1 )} = \tilde{L} {a}^{( t )} = ( \tilde{L} {\tilde{L}}^{T} ) {h}^{( t )} \qquad ( 5 )$$

where a^{(t)} represents a vector of authority scores of the web pages at iteration t and h^{(t)} represents a vector of hub scores of the web pages at iteration t. In one embodiment, the importance system may factor in the level of the to web page when determining the importance of web pages. Since the importance of a web page decreases as its level is deeper into a web site hierarchy, this decrease is considered a level punishment. The importance system represents the level punishment as a diagonal matrix according to the following equation:
P−diag(l/l₁, l/l₂, . . . , l/lₙ) (6)
In this example, the importance system represents the punishment for a level as the reciprocal of the level. For example, the punishment for a web page at level 3 is ⅓. Alternatively, the importance system may use a non-linear function to represent the punishment (e.g., reciprocal of the square of the level- 1/9 for level 3) or other arbitrary function. The importance system represents Equation 5 with the addition of level punishment according to the following equation:

$${a}^{( t + 1 )} = P \cdot {\tilde{L}}^{T} {h}^{( t )} = ( P {\tilde{L}}^{T} P \tilde{L} ) {a}^{( t )} \\ {h}^{( t + 1 )} = P \cdot \tilde{L} {a}^{( t )} = ( P \tilde{L} P {\tilde{L}}^{T} ) {h}^{( t )} \qquad ( 7 )$$

The importance system can also factor level punishment into the calculation of the weight of the link. In such a case, the importance system may represent the weight of a link according to the following equation:

$${w}_{j \vert i} = \frac{1}{{l}_{i} \cdot {l}_{j} \cdot {l}_{anc ( i , j )}} \qquad ( 8 )$$

where 1/lⱼ represents the level punishment for web page j.

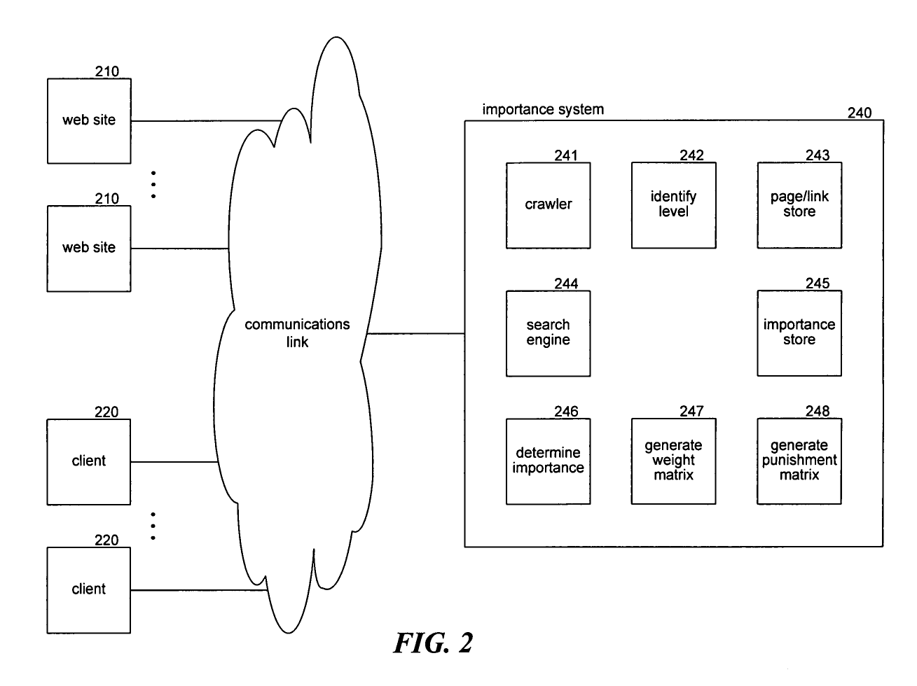

FIG. 2 is a block diagram that illustrates components of the importance system in one embodiment. The importance system 240 is connected to web sites 210 and client computing devices 220 via communications link 230. The importance system includes a crawler 241, an identify level component 242, and a page/link store 243. The crawler may be a conventional crawler for crawling web pages and stores its results in the page/link store. The identify level component may identify the level of each web page based on analysis of the URL of the web page. The identify level component may also identify common ancestor web pages for linked web pages. The identify level component may store its results in the page/link store. The importance system also includes a determine importance component 246, a generate weight matrix component 247, and a generate punishment matrix component 248. The determine importance component determines the importance of web pages of the page/link store based on the weights of the links derived from the level of the web pages and stores the results in an importance store 245. The determine importance component invokes the generate weight matrix component to generate the weight matrix for the links of the web pages. The determine importance component may also invoke the generate punishment matrix component to generate the punishment matrix. The determine importance component may calculate importance based on an importance algorithm such as HITS or PageRank that is modified to use the generated weight matrix and punishment matrix. The importance system may also include a search engine 244 that performs conventional searching for web pages and then ranks the web pages by factoring in the importance of the web pages as indicated by the importance store.

The computing devices on which the importance system may be implemented may include a central processing unit, memory, input devices (e.g., keyboard and pointing devices), output devices (e.g., display devices), and storage devices (e.g., disk drives). The memory and storage devices are computer-readable media that may contain instructions that implement the importance system. In addition, the data structures and message structures may be stored or transmitted via a data transmission medium, such as a signal on a communications link. Various communications links may be used, such as the Internet, a local area network, a wide area network, or a point-to-point dial-up connection.

The importance system may receive queries from various client computing systems or devices including personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The importance system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments. For example, the importance system may not include a crawler or a search engine.

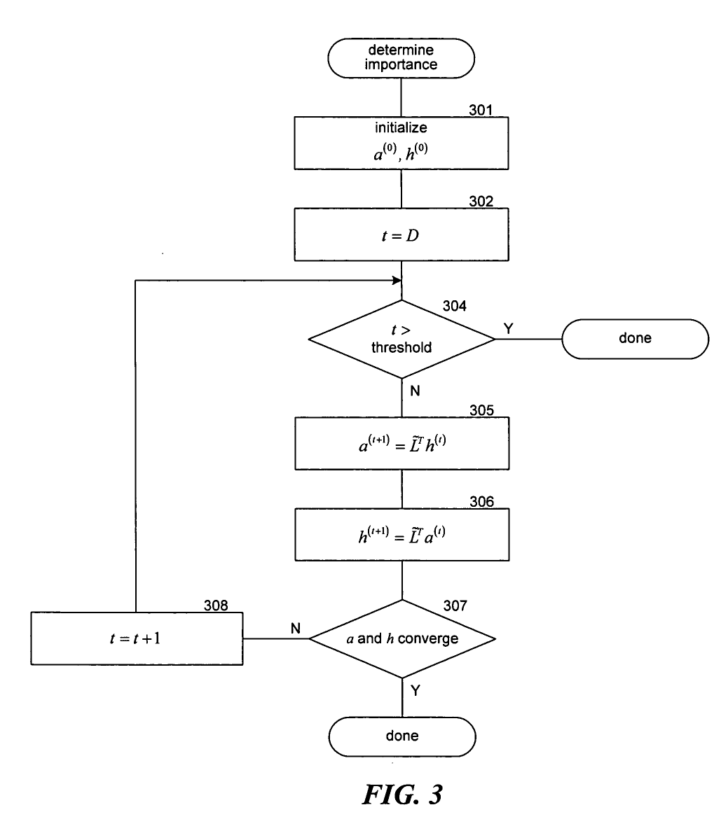

FIG. 3 is a flow diagram that illustrates the processing of the determine importance component of the importance system in one embodiment. The component may initially invoke the generate weight matrix component and the generate punishment matrix component to generate the matrices needed to determine the importance of the web pages. In this example, the component implements a HITS-based algorithm to determine the importance of the web pages. In block 301, the component initializes the authority and hub scores for the web pages. In block 302, the component sets the iteration count to the initial iteration. In decision block 304, if enough iterations have already been performed, then the component completes, else the component continues at block 305. In block 305, the component calculates the authority scores for the next iteration based on the hub scores of the previous iteration and the weight matrix. Although not shown, the component may also factor in the punishment matrix. In block 306, the component calculates the hub scores for the next iteration based on the authority scores of the previous iteration. In decision block 307, if the authority and hub scores for the web pages converge to a solution, then the component completes, else the component continues at block 308. In block 308, the component selects the next iteration and loops to block 304 to perform the next iteration.

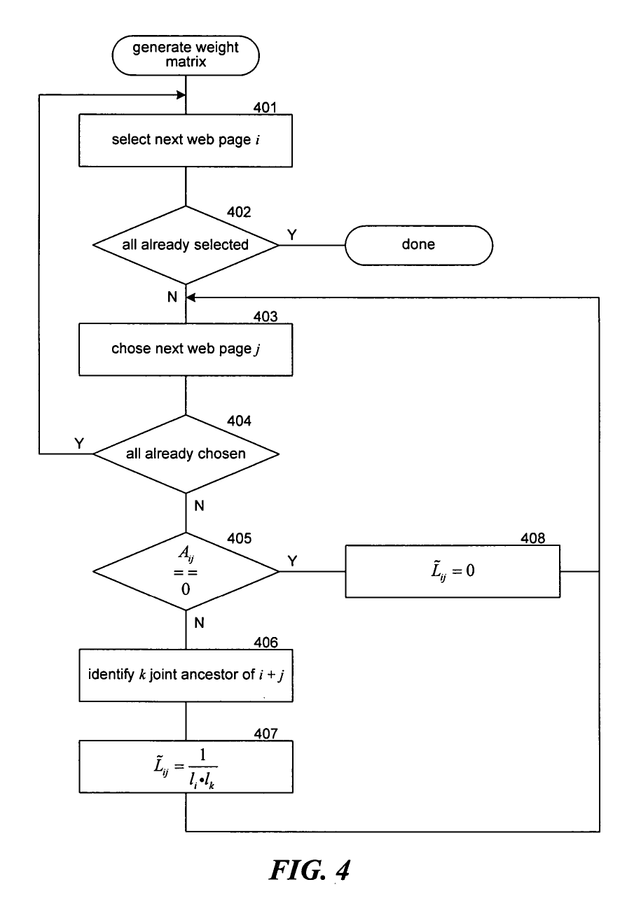

FIG. 4 is a flow diagram that illustrates the processing of the generate weight matrix component of the importance system in one embodiment. The rows and columns of the weight matrix represent the web pages. The component loops selecting web pages represented by rows and then for each web page chooses each web page represented by columns. The component calculates the weight of the link between the selected and chosen web pages. In block 401, the component selects the next web page. In decision block 402, if all the web pages have already been selected, the component completes, else the component continues at block 403. In block 403, the component chooses the next web page for the currently selected web page. In decision block 404, if all the web pages have already been chosen, then the component loops to block 401 to select the next web page, else the component continues at block 405. In block 405, if there is no link between the selected and chosen web pages, then the component continues at block 408, else the component continues at block 406. In block 406, the component identifies the closest common ancestor for the selected and chosen web pages. In block 407, the component sets the weight of the link from the selected web page to the chosen web page and loops to block 403 to choose the next web page. In block 408, the component sets the weight of the link from the selected web page to the chosen web page to zero and then loops to block 403 to choose the next web page.

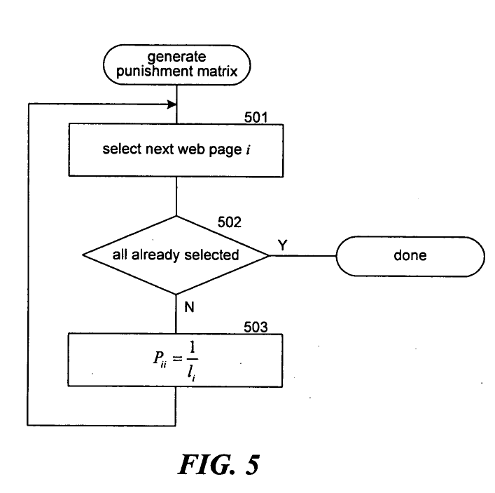

FIG. 5 is a flow diagram that illustrates the processing of the generate punishment matrix component of the importance system in one embodiment. The component loops selecting each web page and sets the diagonal of the punishment matrix. In block 501, the component selects the next web page. In decision block 502, if all the web pages have already been selected, the component completes, else the component continues at block 503. In block 503, the component sets the punishment for the selected web page to the reciprocal of the level of that web page and then loops to block 501 to select the next web page.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. For example, the term “page” may refer to any hierarchically arranged content into a collection of content that includes inter-content links. The content may include documents, display pages, web pages, electronic mail messages, and so on. Accordingly, the invention is not limited except as by the appended claims.

I/We claim:

1. A system for determining importance of pages, comprising:
a component that determines a weight of a link between a from page and a to page, the weight being based on a level of the from page within a hierarchy of pages that contains the from page; and
a component that calculates importance of a page based on the weights of links from from pages to the page.

2. The system of claim 1 wherein the weight is calculated according to the following equation:
$${\tilde{w}}_{wj \vert i} = \frac{1}{{l}_{i} \cdot {l}_{anc ( i , j )}}$$
where \tilde{w}_{wj|i} is the weight of a link from page i to page j, lᵢ is the level of page i, and l_{anc(i,j)} is the level of the closest common ancestor page of page i and page j.

3. The system of claim 1 wherein the weight varies non-linearly based on level.

4. The system of claim 1 wherein the weight is a linear weight that is biased based on level.

5. The system of claim 1 wherein the importance is calculated based on an algorithm that factors in hub and authority scores of pages.

6. The system of claim 5 where the importance is based on the following equation:
$${a}^{( t + 1 )} = {\tilde{L}}^{T} {h}^{( t )} = ( {\tilde{L}}^{T} \tilde{L} ) {a}^{( t )}$$
$${h}^{( t + 1 )} = \tilde{L} {a}^{( t )} = ( \tilde{L} {\tilde{L}}^{T} ) {h}^{( t )}$$
where a is a vector of authority scores of pages, h is a vector of hub scores of pages, and \tilde{L} is a matrix of weights of links between pairs of pages.

7. The system of claim 1 wherein the importance is calculated based on a page rank algorithm with the weights as values of an adjacency matrix.

8. The system of claim 1 wherein the calculated importance of a page factors in the level of the page.

9. The system of claim 8 wherein the calculated importance of a page decreases as its depth within a hierarchy increases.

10. The system of claim 1
wherein the weight is calculated according to the following equation:
$${\tilde{w}}_{j \vert i} = \frac{1}{{l}_{i} \cdot {l}_{anc ( i , j )}}$$
where w_{j|i} is the weight of a link from page i to page j, lᵢ is the level of page i, and l_{anc(i,j)} is the level of the closest common ancestor page of page i and page j;
wherein the importance is based on the following equation:
$${a}^{( t + 1 )} = {\tilde{L}}^{T} {h}^{( t )} = ( {\tilde{L}}^{T} \tilde{L} ) {a}^{( t )}$$
$${h}^{( t + 1 )} = \tilde{L} {a}^{T} = ( \tilde{L} {\tilde{L}}^{T} ) {h}^{( t )}$$
where a is a vector of authority scores of pages, h is a vector of hub scores of pages, and \tilde{L} is a matrix of weights of links between pairs of pages; and
wherein the calculated importance of a page decreases as its depth within a hierarchy increases.

11. A computer-readable medium containing instructions for controlling a computing device to determine weights of links between web pages, by a method comprising:
providing levels of web pages within web sites; and
calculating weights of links between from web pages and to web pages based on the levels of the from web pages and the levels of the to web pages.

12. The computer-readable medium of claim 11 wherein the weights are calculated according to the following equation:
$${w}_{j \vert i} = \frac{1}{{l}_{i} \cdot {l}_{j} \cdot {l}_{anc ( i , j )}}$$
where w_{j|i}is the weight of a link from page i to page j, lᵢ is the level of page i, lⱼ is the level of web page l, and l_{anc(i,j)} is the level of the closest common ancestor page of page i and page j.

13. The computer-readable medium of claim 11 wherein the weights of links decrease as the depths of the to web pages within a hierarchy increase.

14. The computer-readable medium of claim 11 wherein the weights of links increase as the depths of the from web pages within a hierarchy decrease.

15. The computer-readable medium of claim 11 including calculating importance of web pages based on the calculated weights of links between from web pages and to web pages.

16. The computer-readable medium of claim 15 wherein the importance is calculated based on an algorithm that factors in hub and authority scores of web pages.

17. A system for determining importance of web pages, comprising:
a component that calculates importance of web pages based on links between from web pages and to web pages wherein the calculated importance of a web page decreases as its depth within a hierarchy increases.

18. The system of claim 17 wherein the importance is calculated based on an algorithm that factors in hub and authority scores of web pages.

19. The system of claim 17 wherein the importance of a web page increases as the depth of a web page within a hierarchy with a link to it decreases.

20. The system of claim 18 wherein the importance is calculated based on an algorithm that factors in hub and authority scores of web pages.
